(19) United States
(12) Patent Application Publication
(10) Pub. No.: US 2017/0313322 A1
(43) Pub. Date: Nov. 2, 2017

(54) SHARING VEHICLE SETTING DATA

(71) Applicant: Google Inc., Mountain View, CA (US)

(72) Inventors: Joseph M. Onorato, Cambridge, MA (US); Andrew Scott Brenner, Sunnyvale, CA (US); Daniel Holle, San Francisco, CA (US); Patrick Brady, San Francisco, CA (US)

(21) Appl. No.: 15/581,598

(22) Filed: Apr. 28, 2017

Related U.S. Application Data
(60) Provisional application No. 62/330,664, filed on May 2, 2016.

(51) Int. Cl. B60W 50/00; G06Q 50/00; G07C 5/00; B60W 50/14

(52) U.S. Cl. CPC B60W 50/0098; G07C 5/008; G06Q 50/01; B60W 2420/42; B60W 2540/28; B60W 2050/146; B60W 2550/40

(57) ABSTRACT

Vehicle setting data received from a vehicle is processed according to preferences and rules set forth by the vehicle's driver. The processed vehicle setting data can be shared with various third-parties.

### CROSS-REFERENCE TO RELATED APPLICATION

This application claims priority from U.S. Provisional Patent Application No. 62/330,664, filed May 2, 2016, which is incorporated herein by reference.

### FIELD

This disclosure generally relates to automobiles.

### BACKGROUND

Vehicle setting values are often specific to a particular driver. Data for vehicle setting values used by drivers is often unavailable to parties that may be interested in learning more about one or more drivers' vehicle setting values.

### SUMMARY

This disclosure generally describes a system and method for sharing vehicle setting data.

According to implementations, vehicle setting data and driver preferences are received from a vehicle. The vehicle setting data is processed according to the driver preferences. The processed vehicle setting data can be shared with various third-parties. For example, in some implementations, the processed vehicle setting data can be shared in an anonymous manner with vehicle manufacturers so that the manufacturers can be made aware of typical vehicle settings preferred by drivers of the manufacturers' vehicles. In some implementations, an individual, such as a race car driver, may opt to share vehicle setting values with fans through one or more social media networks specified in the driver preferences. Fans may also compare their vehicle settings with the race car driver to see how closely their own vehicle setting values match the race car driver's vehicle setting values.

Innovative aspects of the subject matter described in this specification include, in some implementations, a computer-implemented method to perform actions. The actions include receiving (i) vehicle setting data for one or more vehicles associated with a particular driver, and (ii) vehicle setting preference information for the particular driver. The vehicle setting data is processed by one or more processors based on the vehicle setting preference information for the particular driver and stored, by the one or more processors, in a cloud-based server. The processed vehicle setting data is transmitted to one or more third parties based on the vehicle setting preference information.

Implementations may each optionally include one or more of the following features. For instance, in some implementations, the vehicle setting data includes one or more of mirror positions, a driver seat position, steering wheel position, foot pedal positions, radio station presets, radio stations tuned into, heating, ventilation, air conditioning (HVAC) settings, vehicle lighting preferences, wiper speed settings, navigation settings, camera bumper settings, safety alert settings, child lock settings, and window lock settings.

In some implementations, vehicle setting preference information for the particular driver includes one or more of: data identifying a social network to share one or more portions of the vehicle setting data with; data identifying a contact in a social network who can receive one or more portions of the vehicle setting data; data indicative of one or more rules designated by the particular driver for processing the vehicle setting data; data indicating whether all portions of the vehicle setting data or only one or more portions selected by the particular driver are to be shared; and data indicative of a selection by the driver to abstract the vehicle setting data.

In some implementations, processing the vehicle setting data based on the vehicle setting preference information for the particular driver includes abstracting the vehicle setting data for the particular driver to remove identification information of the particular driver.

In some implementations, processing the vehicle setting data based on the vehicle setting preference information for the particular driver includes one or more of: generating one or more driver profiles based on the vehicle setting data associated with a plurality of drivers including the particular driver; and generating one or move vehicle make and model profiles based on the vehicle setting data associated with a plurality of drivers including the particular driver.

In some implementations, storing the processed vehicle setting data in the cloud-based server includes storing the processed vehicle setting data in one or more of (I) an Internet cloud-based database, and (II) a portable electronic device associated with the particular driver.

In some implementations, storing the processed vehicle setting data in the cloud-based server includes storing the processed vehicle setting data based on one or more of: (I) a vehicle make or model associated with the processed vehicle setting data, (II) a driver profile associated with the processed vehicle setting data, and (III) an identified driver profile associated with the processed vehicle setting data.

In some implementations, storing the processed vehicle setting data in the cloud-based server includes storing the processed vehicle setting data in response to determining that rules included in the vehicle setting preference information for the particular driver are satisfied.

In some implementations, the one or more third parties include: one or more manufacturers, respectively, of the one or more vehicles identified in the vehicle setting data; a social network; a ride-sharing organization; a supplier of vehicle parts; and one of more contacts of the particular driver.

In some implementations, the actions further include receiving vehicle setting data associated with a plurality of drivers, determining a particular vehicle make and model that is detected in (I) the vehicle setting data associated with a plurality of drivers and (II) the vehicle setting data for one or more vehicles associated with the particular driver, and determining vehicle setting values for the determined particular vehicle make and model based on the vehicle setting data associated with a plurality of drivers and the vehicle setting data for one or more vehicles associated with the particular driver. The transmitting of the processed vehicle setting data to the one or more third parties based on the vehicle setting preference information includes transmitting the vehicle setting values for the identified particular vehicle make and model.

In some implementations, the actions further include receiving vehicle setting data associated with a plurality of drivers, determining a particular driver profile based on (I) the vehicle setting data associated with a plurality of drivers and (II) the vehicle setting data for one or more vehicles associated with the particular driver, and determining vehicle setting values for the determined particular driver profile based on the vehicle setting data associated with a plurality of drivers and the vehicle setting data for one or more vehicles associated with the particular driver. The transmitting of the processed vehicle setting data to the one or more third parties based on the vehicle setting preference information includes transmitting the vehicle setting values for the identified particular driver profile to a device of a driver having a profile matching the identified particular driver profile.

In some implementations, the actions further include receiving vehicle setting data associated with a plurality of drivers, and detecting one or more vehicle setting patterns in one or more of the vehicle setting data associated with a plurality of drivers and the vehicle setting data for one or more vehicles associated with the particular driver. The transmitting of the processed vehicle setting data to the one or more third parties based on the vehicle setting preference information includes transmitting data indicative of the one or more vehicle setting patterns.

In some implementations, the one or more vehicle setting patterns include: one or more patterns of vehicle setting values associated with a particular demographic group of drivers; one or more patterns of vehicle setting values associated with a particular vehicle make and model; and one or more patterns of vehicle setting values associated with a particular driver profile.

In some implementations, the actions further comprise determining a value indicative of a level of similarity between (I) vehicle setting values included in the vehicle setting data for the one or more vehicles associated with the particular driver, and (II) vehicle setting values included in a profile of a driver other than the particular driver. The actions further include transmitting data including the value indicative of the level of similarity to a device associated with the particular driver.

Other implementations of these aspects include corresponding systems, apparatus, computer-readable storage mediums, and computer programs configured to implement the actions of the above-noted methods.

The details of one or more implementations are set forth in the accompanying drawings and the description below. Other features and advantages will become apparent from the description, the drawings, and the claims.

### BRIEF DESCRIPTION OF THE DRAWINGS

FIG. 1 depicts a portable vehicle settings data sharing system.

FIG. 2 depicts an exemplary implementation of a network server.

FIG. 3 depicts exemplary operations executed by a network server to share vehicle settings.

FIG. 4 depicts a flowchart of exemplary operations executed by a vehicle and other system devices so a driver may share vehicle settings with third parties.

FIGS. 5A, 5B, and 5C depict exemplary implementations of the vehicle settings data sharing system and method.

Like reference numbers and designation in the various drawings indicate like elements.

### DETAILED DESCRIPTION

This disclosure generally describes methods and systems for sharing vehicle setting data.

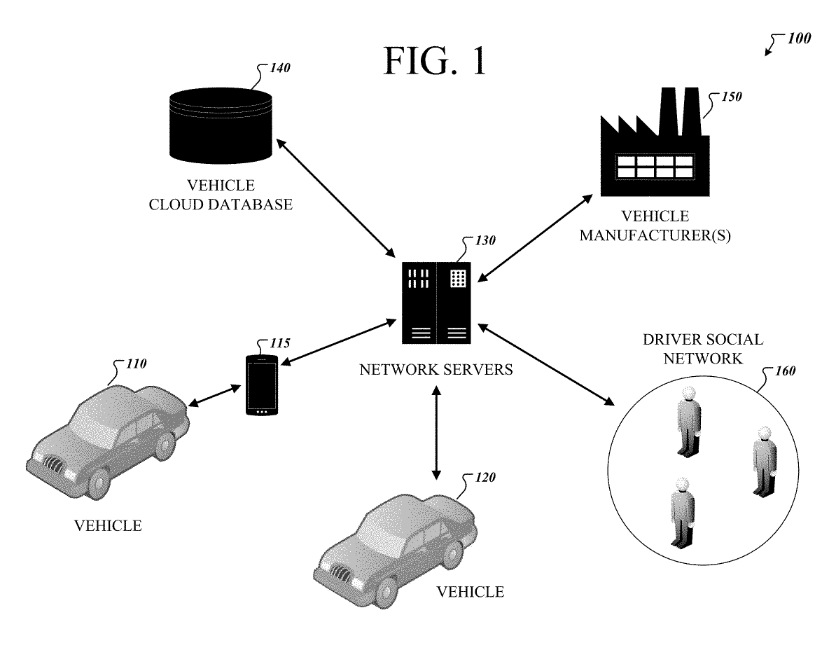

FIG. 1 depicts a vehicle settings data sharing system 100 that includes vehicle 110, user device 115, vehicle 120, one or more network servers 130, a vehicle cloud database 140, one or more vehicle manufacturers 150, and a driver social network 160. It should be understood that although two vehicles 110, 120 are shown in system 100, any suitable number of vehicles may be present in the system 100 at any time.

System 100 may include one or more networks that are configured to provide network access, data transport, and other services to any interface connected to the one or more networks. In general, the one or more networks may include and implement commonly-defined network architectures including those defined by standards bodies, such as the Global System for Mobile communication (GSM) Association, the Internet Engineering Task Force (IETF), and the Worldwide Interoperability for Microwave Access (WiMAX) forum. For example, the one or more networks may implement one or more of a GSM architecture, a General Packet Radio Service (GPRS) architecture, a Universal Mobile Telecommunications System (UMTS) architecture, and an evolution of UMTS referred to as Long Term Evolution (LTE). The one or more networks may implement a WiMAX architecture defined by the WiMAX forum or a Wireless Fidelity (WiFi) architecture. The one or more networks may include, for instance, a local area network (LAN), a wide area network (WAN), the Internet, a virtual LAN (VLAN), an enterprise LAN, a layer 3 virtual private network (VPN), an enterprise IP network, or any combination thereof.

The one or more networks may include access points, storage systems, cloud systems, modules, one or more databases including vehicle cloud database 140, and servers including one or more network servers 130. The one or more network servers 130 may include any suitable computing device coupled to the one or more networks, including but not limited to a personal computer, a server computer, a series of server computers, a mini computer, and a mainframe computer, or combinations thereof. The one or more network servers 130 may also include a web server, or a series of servers, running a network operating system, examples of which may include but are not limited to Microsoft® Windows® Server, Novell® NetWare®, or Linux®. The one or more network servers 130 may be used for and/or provide cloud and/or network computing. Although not shown in the figures, the server may have connections to external systems providing messaging functionality such as e-mail, SMS messaging, text messaging, and other functionalities, such as advertising services, search services, etc.

In some implementations, the one or more network servers 130 may send and receive data using any technique for sending and receiving information including, but not limited to, using a scripting language, a remote procedure call, an email, an application programming interface (API), Simple Object Access Protocol (SOAP) methods, Common Object Request Broker Architecture (CORBA), HTTP (Hypertext Transfer Protocol), REST (Representational State Transfer), any interface for software components to communicate with each other, using any other known technique for sending information from a one device to another, or any combination thereof.

In some implementations, the one or more networks may include a cloud system that may provide Internet connectivity and other network-related functions. For example, the cloud system may provide storage services for at least a portion of the data transmitted between components of system 100.

System 100 also includes a vehicle cloud database 140, which may include a cloud database or a database managed by a database management system (DBMS). A DBMS may be implemented as an engine that controls organization, storage, management, and retrieval of data in a database. DBMSs frequently provide the ability to query, backup and replicate data, enforce rules, provide security, do computation, perform change and access logging, and automate optimization. A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. Data structures can include fields, records, files, objects, and any other applicable known or convenient structures for storing data. A DBMS may also include metadata about the data that is stored.

In some implementations, the vehicle cloud database 140 may store vehicle setting data that may be specific to a particular vehicle make and model, specific to a particular driver, specific to a particular vehicle, or may be abstract vehicle setting values associated with a particular driver profile. The vehicle cloud database 140 may maintain vehicle setting data categorized by driver, driver profile, or by vehicle make and model.

Vehicle settings may include mirror positions, seat position, steering wheel position, foot pedal positions, radio station presets, radio stations tuned into by the driver, heating, ventilation, air conditioning (HVAC) settings, lighting preferences, e.g., fog lights on or off, internal light settings, wiper speed settings, navigation settings, camera bumper settings, safety alert settings, e.g., low fuel alerts, blind spot alerts, child lock settings, and window lock settings. In general, the vehicle settings may include any driver or passenger-configurable option or setting in a vehicle.

Vehicle settings specific to a vehicle may have a range of values and corresponding limits for a particular vehicle setting. For example, the vehicle cloud database 140 may store a first range of positions that a driver seat position can be adjusted in one vehicle and a second range of positions that a driver seat position can be adjusted in another vehicle. Accordingly, the vehicle cloud database 140 may maintain a record of different vehicles, and for each vehicle, the vehicle options, specifications, and the range of particular settings within the vehicle. It should also be appreciated that different vehicles may have different settings and operation modes. For example, one vehicle may be configured to operate in a sports mode and may have vehicle setting values applicable or selected for the sports mode. Another vehicle may be configured to operate in a highway mode and may have vehicle setting values applicable or selected for the highway mode.

In some implementations, the vehicle cloud database 140 may store driver identification data that includes, for example, one or more of a user name or identification, password, driver's license data, or biometric data of the driver. The vehicle cloud database 140 may also store information associated with vehicles the driver has previously driven and vehicle setting values the driver utilized in the respective vehicles. For example, the vehicle cloud database 140 may store a first foot pedal position that the driver used in a one car and a second foot pedal position that the driver used in another vehicle. The first foot pedal and the second foot pedal position may be the same in some cases and different in other cases.

In some implementations, the vehicle cloud database 140 may maintain a driver profile and store the driver identification data and the information associated with vehicles the driver has previously driven in the driver profile. The driver profile may also include vehicle setting data that has been abstracted and is associated with the driver.

In some implementations, the driver profile may include a likely physical profile of the driver, which includes data indicating various physical characteristics of the driver such as, for example, height, arm length, and leg length. The various physical characteristics of the driver can be estimated based on average vehicular setting values used by a driver or, in some cases, vehicular settings for a car most frequently driven by the driver. For example, if a driver generally sets the driver car seat position at a position close to the steering wheel in multiple cars or in a car the driver most frequently drives, the likely height of the driver may be determined to be, for example, less than 5′6″. In another example, if a driver generally sets the driver car seat position at a maximum distance away from the steering wheel in multiple cars, the likely height of the driver may be determined to be, for example, at least 6′.

Various different and suitable methodologies may be used to determine the likely physical characteristics of a driver. For example, in some implementations, a reference table may be used to determine a corresponding driver height from a seat position or distance from the steering wheel of a particular vehicle. In some implementations, a driver may be requested through the vehicle navigation system or the driver's portable electronic device to provide information on the driver's physical characteristics. In some implementations, an alignment or orientation of mirrors may be used to determine the likely location of a driver's head and a likely height of the driver.

In addition to the likely physical characteristics of a driver, the driver profile may also include data indicative of personal preferences of the driver. For example, data indicating the ambient temperature within a car, radio station presets, lighting settings, safety alert settings, child lock settings, or window lock settings preferred by the driver may be stored in the driver profile.

In some implementations, the driver's preferences may also include: data identifying a social network with which one or more portions of the driver's vehicle setting data can be shared with; data identifying a contact in a social network who can receive one or more portions of the driver's vehicle setting data; data indicative of one or more rules designated by the particular driver for processing the driver's vehicle setting data; data indicating whether all portions of the vehicle setting data or only one or more portions selected by particular driver can be shared; and data indicative of a selection by the driver to abstract the driver's vehicle setting data.

The rules designated by the driver may include various suitable rules such as rules indicating when or how often the vehicle setting data can be obtained or shared, rules indicating one or more types or names of destinations that can receive the vehicle setting data to, rules indicating how the vehicle setting data can be shared or transmitted, and rules indicating privacy selections of the driver.

For example, a driver may be provided with controls allowing the driver to make an election as to both if and when systems, programs or features described herein may enable collection of driver information (e.g., physical characteristics, information about a driver's social network, social actions or activities, profession, a driver's preferences, or a driver's current location), and if the driver is sent content or communications from a server. In addition, certain data may be treated in one or more ways before it is stored or used, so that personally identifiable information is removed. For example, a driver's identity may be treated so that no personally identifiable information can be determined for the driver, or a driver's geographic location may be generalized where location information is obtained (such as to a city, ZIP code, or state level), so that a particular location of a driver cannot be determined. Thus, the driver may have control over what information is collected about the driver, how that information is used, and what information is provided to the driver.

The process for removing personally identifiable information from the vehicle setting data results in abstracted vehicle setting data. The abstracted vehicle setting data may include general driver profile data of the driver without any identification information.

Each of vehicle 110 and vehicle 120 may be one of an automobile, rickshaw, moped, motor cycle, bicycle, snowmobile, truck, Segway, etc. Vehicle 110 and vehicle 120 may each correspond to one of various suitable makes and models including, for example, a Honda Civic, Honda Accord, Toyota Camry, Volkswagen Beetle, Mercedes Benz CLK, BMW 5 series, Chevrolet Corvette, etc. In some implementations, vehicle 110 and vehicle 120 may each include a vehicle control module to control one or more operations of vehicle 110 and vehicle 120, respectively.

The vehicle control module is configured to communicate directly or indirectly through system 100 to communicate with other system 100 elements such as the one or more network servers 130, user device 115, vehicle cloud database 140, other vehicles, one or more vehicle manufacturers 150, and the driver social network 160. For example, the vehicle control module may communicate with user device 115 to obtain information about a driver carrying the user device 115 or to send information about the vehicle.

In some implementations, the vehicle control module may also be connected to various components and sensors of the vehicle to implement commands and operations or to determine a status of the components and sensors in the vehicle. Accordingly, the vehicle control module may provide status information about a component or sensor in the vehicle to system 100 elements such as the one or more network servers 130 or the user device 115. For example, the vehicle control module can provide a notification if a door is not locked or information indicating the ambient temperature in the vehicle based on data received from components and sensors in the vehicle.

The user device 115 may be any suitable portable electronic device. Examples of a portable electronic device include, but are not limited to, a computer, lap top, personal digital assistant, electronic pad, electronic notebook, telephone, smart phone, television, smart television, a watch, smart glasses, or any electronic device that is connected to a network and has a display. The user device 115 may be any combination of hardware and software and may execute any suitable operating system such as an Android® operating system.

The user device 115 may refer to any portable electronic device that is owned, rented, or possessed by a driver of vehicle 110. The driver of the vehicle 110 may be a renter, owner, or passenger of vehicle 110. The user device 115 may include an application that allows the user device 115 to communicate with vehicle 110 and one or more network servers 130. For example, in some cases, an application on the user device 115 may control the user device 115 to communicate with a vehicle control module in vehicle 110 and to obtain driver vehicle setting values used by a driver who is in possession of the user device 115 and is driving or has driven vehicle 110. The obtained driver vehicle setting values or data may be transmitted to network servers 130 and subsequently stored in vehicle cloud database 140.

The one or more network servers 130 may be configured to communicate with the various elements of system 100 including one or more vehicle manufacturers 150 and one or more social networks 160 associated with the driver. The vehicle manufacturers 150 may include any vehicle manufacturer such as Toyota, Honda, Mercedes-Benz, etc. In some implementations, the vehicle manufacturers 150 may also include suppliers of vehicle parts. The social networks 160 may include any suitable network such as Facebook, Twitter, Instagram, and may also include social network websites and blogs. The social networks 160 may include friends, family, or followers of a driver. In some implementations, the social networks 160 may also include additional third party networks and organizations, such as corporations and ride sharing service providers.

Communications with the one or more vehicle manufacturers 150 and one or more social networks 160 associated with the driver are conducted in accordance with the driver's preferences and rules. For example, vehicle setting data may be transmitted to manufacturers 150 or social networks 160 that the driver has selected, consented to, or waived an objection to. In some implementations, the driver may select a particular social network or one or more contacts, friends, or peers in a social network.

As shown in FIG. 1, network servers 130 may communicate directly with a vehicle 120 or may communicate with a vehicle 110 through a user device 115. In some implementations, the communication between network servers 130 and vehicles 110 and 120 may include abstracted vehicle setting data received from vehicles 110 and 120. The abstracted vehicle setting data includes metadata identifying a make and model of the vehicle (e.g., vehicles 110 and 120) the abstracted vehicle setting data is received from, and values of vehicle settings being used in vehicles 110 and 120. The abstracted driver vehicle setting data may include data indicative of various vehicle setting values such as one or more of mirror positions, a driver seat position, steering wheel position, foot pedal positions, radio station presets, heating, ventilation, air conditioning (HVAC) settings, vehicle lighting preferences, wiper speed settings, navigation settings, camera bumper settings, safety alert settings, child lock settings, and window lock settings.

In some implementations, if the drivers of vehicles 110 and 120 give consent to sharing driver profile information, anonymized driver profile information such as a likely height, a likely arm length, and a likely leg length of the drivers may also be communicated to network servers 130 along with the abstracted vehicle setting data. The anonymized driver profile information does not include any identification information of the driver.

The network servers 130 may store the abstracted vehicle setting data in vehicle cloud database 140 in various suitable manners. For example, in some cases, the abstracted vehicle setting data may be categorized according to the type of vehicle make and model. In some cases, the abstracted vehicle setting data may be categorized according to a type of driver profile. In some implementations, the vehicle cloud database 140 maybe implemented as a part of the network servers 130.

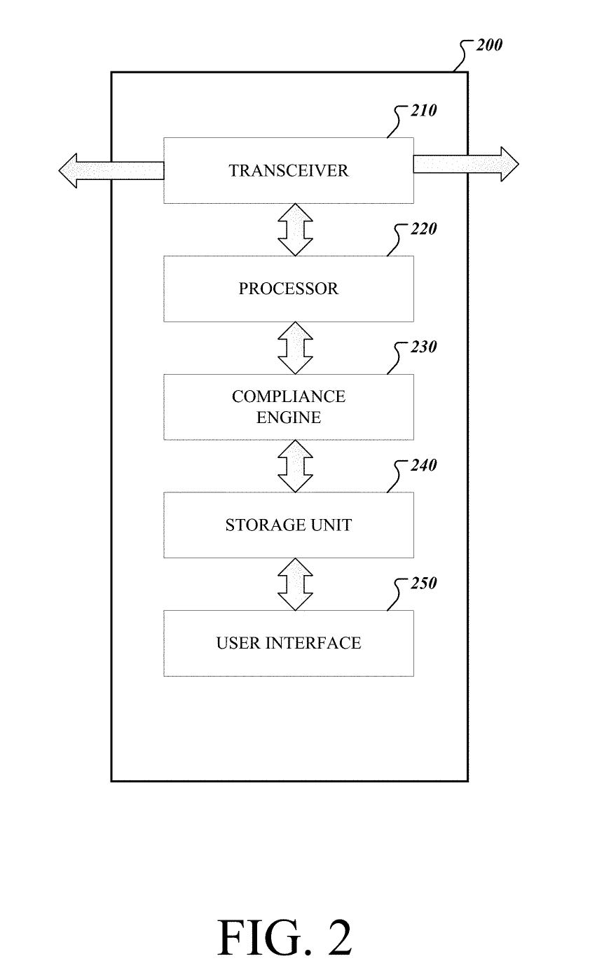

FIG. 2 illustrates an exemplary implementation of a network server 200. As shown in FIG. 2, a network server 200 may include a transceiver 210, a processor 220, a compliance engine 230, a storage unit 240, and a user interface 250. The processor 220 may include one or more neural networks.

A transceiver 210 includes a transmitter and a receiver and may be utilized to communicate with other devices. The transceiver 210 may include amplifiers, modulators, demodulators, antennas, and various other components. The transceiver 210 may communicate with vehicles, vehicle cloud databases, vehicle manufacturers, and driver social networks. The transceiver 210 may direct data received from other devices to other components of the network server 200 such as the processor 230 and storage unit 240. The transceiver 210 may also direct data received from components of the network server 200 to other devices.

The user interface 250 may include a display unit, input unit, and one or more sensors. The sensors may include an optical sensor, capacitive sensor, charge- coupled device sensor, gyroscope, microphone, altimeter, impact sensor, piezoelectric sensor, motion sensor, biosensor, active pixel sensor, and various other sensors that may detect one or more conditions or receive inputs. The input unit may include various devices that are configured to receive one or more inputs. For example, the input unit may include a mouse, touch pad, or keyboard for receiving alphanumeric text.

The display unit in the user interface 250 may display various data. The display unit may be implemented through suitable displays including, for example, a projection display, a liquid crystal display (LCD), or light emitting diode (LED) display. In some implementations, the display unit, input unit, and one or more sensors may be combined into a single integrated component, and, in some implementations, the display unit, input unit, and one or more sensors may be multiple components.

Storage unit 240 may include one or more mass storage devices, e.g., magnetic, magneto optical disks, optical disks, EPROM, EEPROM, flash memory devices, and may be implemented as internal hard disks, removable disks, magneto optical disks, CD ROM, or DVD-ROM disks for storing data. The storage unit 240 may store rules for training neural networks and rules received from drivers for processing vehicle setting data respectively received from the drivers.

The processor 220 may be coupled to all components of the network server 200, and may control the operations of the network server 200. The processor 220 may include various logic circuitry and programs to execute the various implementations described herein.

In some implementations, the processor 220 may include neural network classifiers to classify one or more patterns in vehicle setting data collected from one or more vehicles and drivers. In general, the neural networks may be trained to classify various suitable patterns including, for example, patterns indicative of vehicle setting values associated with a particular demographic group of drivers, patterns indicative of vehicle setting values associated with a particular vehicle make and model, and patterns indicative of vehicle setting values associated with a particular driver profile.

In general, vehicle setting data patterns may be classified in various suitable ways using various suitable methods. For example, the vehicle setting data may be classified according to patterns of vehicle setting data associated with a particular driver, one or more driver profiles, or one or more vehicles' make and model. In some implementations, the processor 230 may aggregate data for a particular driver, one or more driver profiles, or one or more vehicles' make and model.

In some implementations, the processor 220 may process vehicle setting data received from a plurality of drivers or vehicles to generate one or more driver profiles or one or more vehicle make and model profiles. For example, the processor may generate a profile of drivers having a height above or below a particular height and the most frequently used vehicle setting values or average vehicle setting values associated with the height.

In some implementations, network server 200 may also implement a ratings system. The ratings system may compare a particular driver to another driver, a particular driver to a driver profile, a particular driver profile to another driver profile, or a particular vehicle make and model to another vehicle make and model. For example, processor 220 may compare vehicle setting data received from a plurality of sources through transceiver 210, and provide a value indicative of the similarity or difference in the received vehicle settings data from two or more sources.

The compliance engine 230 ensures that the vehicle setting data received from drivers and vehicles are processed according to the preferences and rules of the drivers. When processing vehicle setting data for a particular driver, the compliance engine 230 may obtain the preferences and rules provided by the driver or the driver's vehicle and send instructions to processor 230 to process the driver's vehicle setting data in accordance with the obtained preferences and rules.

For example, if a particular driver has indicated that the driver's vehicle setting data should be abstracted and only shared to a particular social network, the compliance engine 230 will generate instructions for the processor 230 to remove any personally identifiable information from the driver's vehicle setting data and to transmit the abstracted vehicle setting data to the particular social network through transceiver 210.

The compliance engine 230 may also communicate with a vehicle cloud database and storage unit 240 to ensure that data stored in the vehicle cloud database and storage unit 240 complies with the rules and preferences and rules of the drivers.

Although various operations and functions have been described as being performed by processor 220 and compliance engine 230 in network server 200, it should be appreciated that these operations and functions may be performed in any various parts of the system 100. In some implementations, one or more features of the network server 200, such as the compliance engine 230 or operations of the processor 220, can be implemented in a portable electronic device, e.g., user device 115, associated with the driver. For example, an application installed on a driver's portable electronic device can implement operations of the compliance engine 230, processor 220, or other components and modules in the portable electronic device.

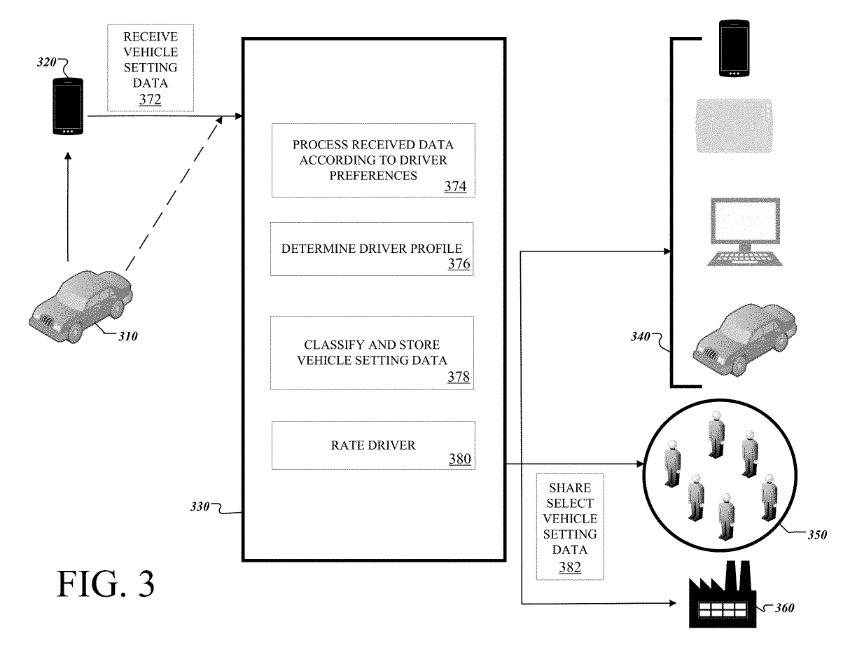

FIG. 3 depicts exemplary operations executed by a network server 330 to share vehicle setting data with one or more third parties, such as one or more social networks 350, one or more vehicle manufacturers 360, and one or more devices 340. The network server 330 may receive vehicle setting data from a user device 320 associated with a driver of vehicle 310 or from a vehicle 310 (operation 372). For the purposes of describing the implementations depicted in FIG. 3, references to vehicle setting data transmitted to the network server 330 from the vehicle 310 include data being transmitted from a vehicle control module in vehicle 310 or from the user device 320 associated with the driver of vehicle 310 to the network server 330. The vehicle setting data may include metadata identifying a make and model of the vehicle 310, values of vehicle settings used in vehicle 310, and driver information.

As noted above, the values of vehicle settings used in vehicle 310 may include values of one or more of mirror positions, a driver seat position, steering wheel position, foot pedal positions, radio station presets, heating, ventilation, air conditioning (HVAC) settings, vehicle lighting preferences, wiper speed settings, navigation settings, camera bumper settings, safety alert settings, child lock settings, and window lock settings. Driver information may include one or more of the likely physical characteristics of the driver of vehicle 310 and data indicative of personal preferences of the driver, which may include driver designated rules for sharing the vehicle setting data.

In some implementations, the vehicle setting data may also include location data indicative of a location of vehicle 310. The location data may be provided in various suitable formats such as global positioning system (GPS) coordinates, street, city, and state address, or latitude-longitude coordinates.

The network server 330 processes the received vehicle setting data according to the preferences of the driver (operation 374). The processing operation may include one or more of identifying a make and model of vehicle 310 using the metadata received in the vehicle setting data, identifying a location at which vehicle 310 is located at the time vehicle 310 sent the vehicle setting data, and identifying the driver of vehicle 310 if the driver chooses not to remain anonymous. If location data is not provided in the received vehicle setting data, the location of the vehicle 310 at the time vehicle 310 sent the vehicle setting data may be determined using one or more of various location determining methods such as location triangulation and GPS-based methods.

In some implementations, if the driver information has not been abstracted by an application executed on user device 320 and the driver has indicated that vehicle setting data should be abstracted, the network server 330 may anonymize the received vehicle setting data to remove data that identifies the driver.

In addition, in some implementations, if the driver has specified which third parties, such as social networks, manufacturers, individuals, or organizations, the driver's vehicle setting data may be shared with in the driver information, the network server 330 may determine whether information, for example, address information such as an email address, IP address, phone number, associated with these third parties is available to transmit vehicle setting data to the third parties.

If the information regarding the third parties is not available, the network server 330 may obtain this information by querying the driver for more information or by searching various sources such as public databases and the Internet. If this information cannot be obtained, the network server 330 may transmit a message to vehicle 310 or user device 320 indicating particular destinations for sharing vehicle data that cannot be reached.

In some implementations, in compliance with the driver's rules, the network server 330 may determine or create a driver profile (operation 376). The driver profile may include the likely physical profile of the driver, one or more vehicles driven by the driver, vehicle settings preferred by the driver for each of the one or more vehicles, and various other information the driver has given authorization for. The likely physical profile of the driver may include data indicating various physical characteristics of the driver such as, for example, height, arm length, and leg length.

If information regarding the driver's physical characteristics is not available, the various physical characteristics of the driver can be estimated based on average vehicular setting values used by a driver or, in some cases, vehicular settings for a car most frequently driven by the driver. For example, as noted above, a reference table may be used to determine a corresponding driver height from a seat position or distance from the steering wheel of the vehicle most frequently driven by the driver.

In some implementations, if the driver elects to share the driver's identity, the driver profile may also include driver identification information. In some implementations, the driver profile may also include one or more destinations that the driver has approved to share the driver's vehicle settings data with. For example, a driver may have authorized sharing the driver's vehicle setting data with a particular family member, with one or more friends, with a particular social network, or a manufacturer of vehicle 310. A destination that has been approved by the driver is designated by the network server 330 as an authorized receiver of the driver's vehicle setting data

The network server 330 may also classify and store the vehicle setting data (operation 378). In particular, the network server 330 may communicate with a vehicle cloud database to classify and store vehicle setting data for multiple drivers and vehicles. The vehicle cloud database includes one or more databases corresponding to particular vehicle make and models and particular driver profiles. For example, the vehicle cloud database may have a database for a particular vehicle make and model and a database of particular driver profiles such as drivers that have a height less than 5′5″ within or separate from the particular vehicle make and model database. In general, various types of databases may be created and included in the vehicle cloud database.

The network server 330 may continuously update the vehicle cloud database as vehicle setting data is received from multiple vehicles and user devices. Accordingly, the vehicle cloud database may accumulate the processed vehicle setting data received from various vehicles and user devices.

In some implementations, the network server 330 may maintain respective counts for different vehicle settings. For example, the network server 330 may maintain a record of how many times a particular vehicle setting is applied in a particular vehicle or by a particular driver profile. This record may be updated each time vehicle setting data is received from a vehicle indicating that the particular vehicle setting is being applied. The network server 330 may then determine a frequency of use or a percentage of use of the particular vehicle setting.

In some implementations, the network server 330 may execute a driver rating operation (operation 380). For example, as noted above, the network server 330 may compare the vehicle setting values of a particular driver to the vehicle setting values of (i) a driver profile similar to the particular driver's profile, (ii) a driver profile different from the particular driver's profile, (iii) profiles of drivers driving the same vehicle make and model as the particular driver, or (iv) drivers in the same geographical area as the particular driver. The network server 330 may provide a value indicative of the similarity or difference in the received vehicle setting data. The rating operation may be performed in response to requests received from a driver of vehicle 310.

The network server 330 may share processed vehicle setting data of vehicle 310 or a driver of the vehicle 310 with one or more third parties (operation 382). The sharing may be performed in accordance with the preferences of a driver of vehicle 310, upon receiving a request from a third party, or in accordance with a predetermined sharing policy.

For example, as noted above, the vehicle setting data received from vehicle 310 may include an indication of which third parties the driver of vehicle 310 would like to share vehicle setting data with. In some cases, the driver profile of the driver of vehicle 310 may also store an indication of the third parties the driver of vehicle 310 would like to share vehicle setting data with. In addition to the third party information, in some cases, received vehicle setting data or driver profile may also include information on the specific types or portions of vehicle setting data the driver of vehicle 310 has authorized to share. The network server 330 may transmit the authorized portions of vehicle setting data based on the preferences of the driver of vehicle 310.

In one example with reference to FIG. 3, driver of vehicle 310 may have indicated one or more friends to share the driver's vehicle setting data such as only the driver's favorite radio stations with the driver's friends. The network server 330 may then transmit data indicative of the driver's favorite radio stations to devices 340 associated with the driver's friends. The devices 340 may include any device with one or more electronic components that is capable of communicating wirelessly over a wireless network. The devices 340 may include, but is not limited to, a smart phone, a laptop, an electronic pad, and a vehicle.

In another example, a celebrity race car driver may have provided authorization for his vehicle settings to be shared with his fans or his fan page on a social network. However, the celebrity race car driver may have elected to abstract his location information so that his location cannot be determined or tracked by the network server 330 or his fans. After processing the race car driver's vehicle setting data, the network server 330 may transmit a message to the social network hosting the fan page with information on the celebrity race car driver's latest vehicle settings.

In another example, a driver in Seattle, Wash., may have given authorization for her vehicle settings to be shared with ride sharing service providers, so that any vehicles offering rides in Seattle, Wash., through the ride sharing service providers may be made aware of the driver's vehicle settings. The network server 330 may then transmit a message including the driver's vehicle setting data to one or more servers associated with ride sharing ride sharing service providers in Seattle, Wash.

In some implementations, the network server 330 may receive a request from a third party such as the vehicle manufacturer 360 to provide vehicle setting data for a particular vehicle make and model. If the vehicle manufacturer 360 is an authorized recipient, anonymized and aggregated vehicle setting data may be transmitted to the vehicle manufacturer 360. For example, if the driver of vehicle 310 has authorized the manufacturer of vehicle 310 to receive vehicle setting data, the network server 330 may provide anonymized portions of the vehicle setting data associated with vehicle 330 or the driver of vehicle 310 to the vehicle manufacturer. In another example, anonymized and aggregated data stored in the vehicle cloud database for the particular make and model of vehicle 310 may be obtained by the network server 330 and provided to the vehicle manufacturer.

In some implementations, an administrator of the network server 330 may have a predetermined sharing policy or agreement to share anonymized vehicle setting data with one or more third parties. For example, the administrator of the network server 330 may have an agreement or policy to share anonymized vehicle setting data with one or more social networks 350 or a ride sharing service provider. The network server 330 may then transmit anonymized vehicle setting data to the social networks 350 or ride sharing service provider according to the terms of the agreement or policy.

In some implementations, the driver of vehicle 310 may request information associated with the driver's vehicle setting data from the network server 330. For example, the driver may request the network server 330 to rank the driver's vehicle setting data by, for example, comparing the driver's vehicle setting values with another driver's vehicle setting values. The other driver may be any person who the network server 330 maintains a driver profile for. The other driver may include, for example, an acquaintance of the driver, a member of the driver's social network, or a professional race driver. The network server 330 may rank the driver's vehicle setting data, as described above, and transmit the ranking information back to the vehicle 310. In some implementations, vehicle setting data may be transmitted from the network server 330 back to the vehicle 310 in response to receiving a request for the vehicle setting data from the driver.

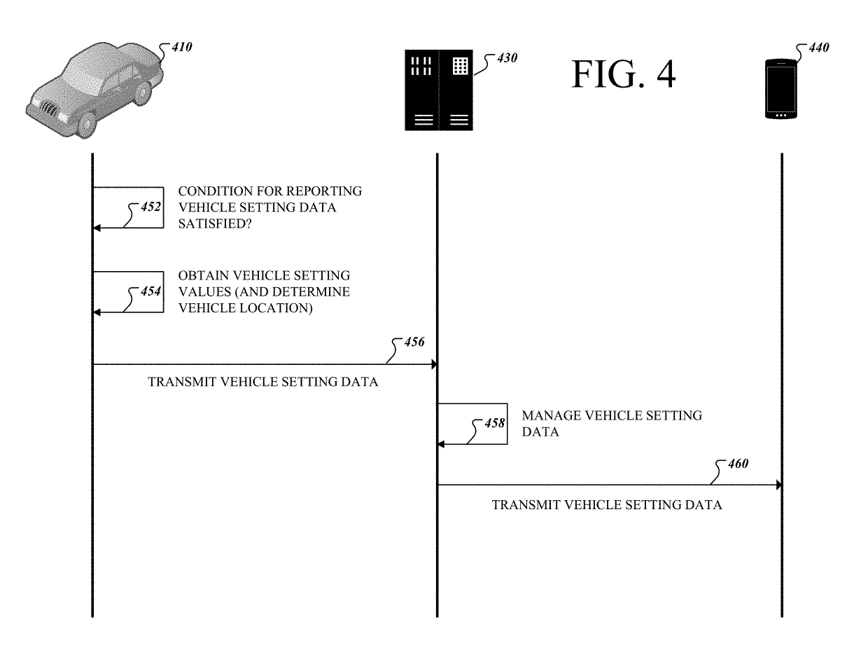

FIG. 4 depicts a flowchart of exemplary operations executed by a vehicle 410, a network server 430, and other devices 440 so a driver may share vehicle settings with one or more third parties. Although FIG. 4 shows a vehicle 410 executing the operations 452-456, these operations may also be executed by a user device associated with a driver of vehicle 410.

Referring to FIG. 4, vehicle 410 may determine whether a condition for reporting vehicle setting data is satisfied (operation 452). The condition for reporting vehicle setting data may include one or more of receiving a request from a driver of vehicle 410 to report vehicle setting data, detecting a change in the vehicle setting values of vehicle 410, and determining that a time for reporting vehicle setting data has arrived according to a schedule set by the driver or manufacturer of vehicle 410. A driver may select one or more of the above-noted conditions as the condition that triggers the operations illustrated in FIG. 4.

In response to determining that a condition for reporting vehicle setting data is satisfied, the vehicle control module in vehicle 410 obtains vehicle setting values from various vehicle components, e.g., lights, gear, mirrors (operation 454). In some implementations, the vehicle control module may also obtain vehicle location information from a navigation system or may use any suitable location determining method such as location triangulation and GPS to obtain vehicle 410's location. In some implementations, the vehicle 410 may request the driver to provide information regarding who the driver would like to share the vehicle setting data with.

The vehicle 410 may then generate and transmit a message to the network server 430 with the vehicle setting data (operation 456). The message includes one or more of vehicle setting values, and optionally vehicle location data identifying a location of vehicle 410 and data identifying one or more third parties the driver would like to share the vehicle setting data with. As noted above, various suitable messaging and communication methods may be used to transmit data to and from a network server.

When the network server 440 receives the vehicle setting data, the network server 440 manages the vehicle setting data by execution operations 374, 376, 378, and 380, as discussed with reference to FIG. 3. The network server 440 may then transmit one or more portions of the vehicle setting data to a device 440 of an authorized third party, as described in operation 382.

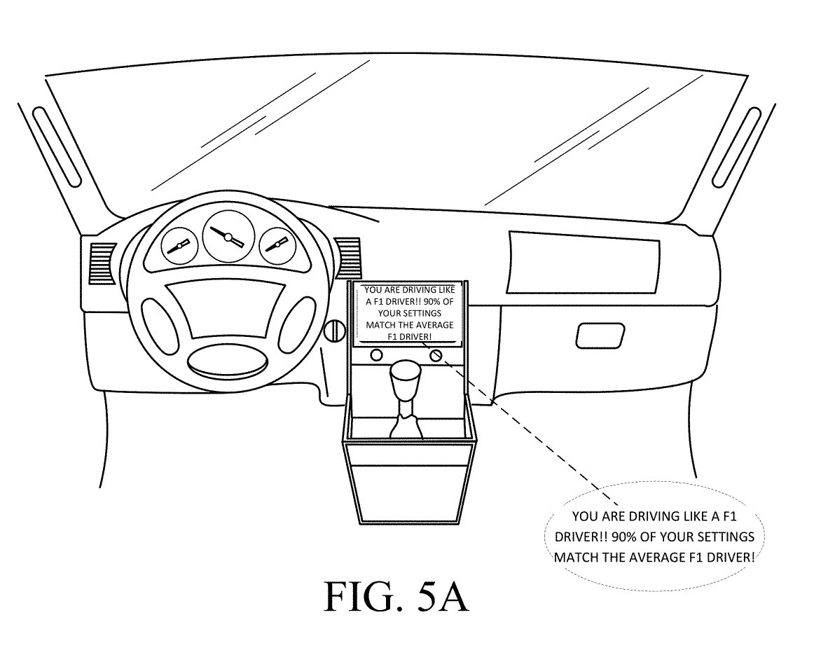

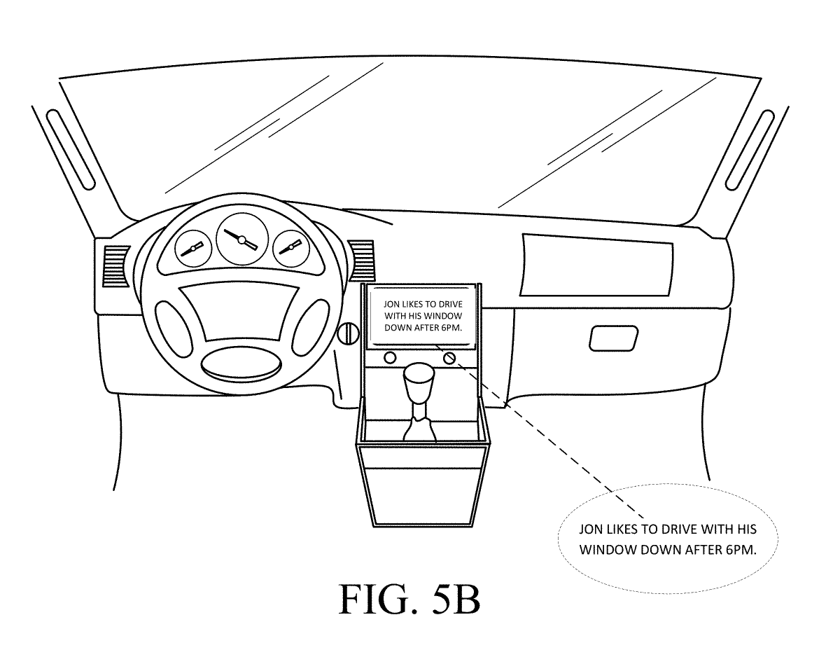

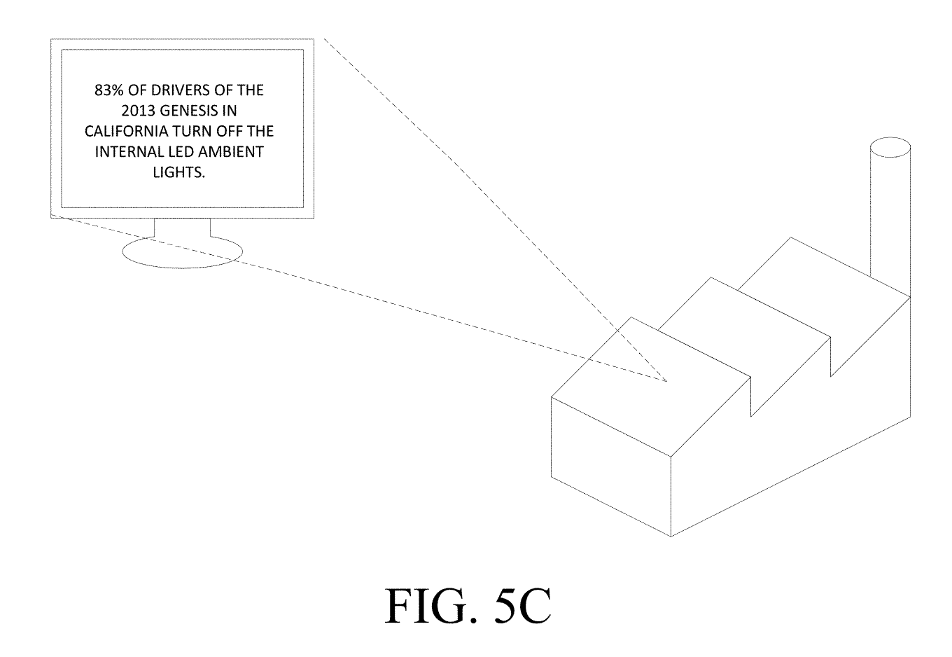

FIGS. 5A, 5B, and 5C illustrate examples of sharing vehicle setting data. Referring to FIG. 5A, a message received from a network server may be displayed in the navigation display of a vehicle. The message communicates to the driver of the vehicle that “YOU ARE DRIVING LIKE A F1 DRIVER!!! 90% OF YOUR SETTINGS MATCH THE AVERAGE F1 DRIVER!.”

As described above, a network server may implement a ratings system which may compare vehicle setting values of a driver with vehicle setting values from another drive profile. In the illustrated example, the network server has stored information on the average vehicle setting values of Formula 1 (F1) drivers. When the network server receives vehicle setting data from the vehicle, the ratings system in the network server compares the vehicle setting values used in the vehicle with vehicle setting values associated with one or more driver profiles such as a F1 driver profile. The ratings system then communicates comparison outcome information to the vehicle indicating that the vehicle settings value in the vehicle has a strong correspondence, for example a 90% similarity, with the vehicle setting values used by the average F1 driver.

The comparison outcome information may be transmitted using various suitable means and in any suitable manner. For example, the comparison outcome information may be transmitted via SMS, e-mail, or data transmitted through any wireless signal. In FIG. 5A, the comparison outcome information is transmitted to the vehicle control module of the vehicle, which then displays the received information on a navigation display. In some cases, the comparison information may be transmitted to a portable electronic device associated with the user.

In some implementations, the ratings system will transmit comparison outcome information to a vehicle or driver if the match between the vehicle setting values is greater than a particular threshold, for example, 70%. In some implementations, the ratings system will transmit comparison information for the highest matching profile, driver, or vehicle make and model.

Referring to FIG. 5B, a driver or celebrity, Jon, has indicated that he would like to share his vehicle setting data with his friends, followers, and family. Thus, after collecting information from Jon's vehicle, the system 100 publishes information regarding Jon's vehicle settings to Jon's social network including friends, followers, and family that he has designated to receive his vehicle setting information.

In the illustrated example in FIG. 5B, the neural networks in the network server determined a pattern in Jon's vehicle setting data. In particular, the neural networks determined that Jon lowers his windows after 6 PM every day when he drives. After determining this pattern, the network server shares this information with Jon's social network per Jon's preference.

FIG. 5C illustrates a computer monitor in an automobile manufacturing facility that has received vehicle setting data from the network server. The received vehicle setting data indicates to the automobile manufacturer that 83% of California drivers that drive one of the manufacturer's vehicles, for example, Genesis, turn off the internal LED ambient lights. This information could indicate to the manufacturer a particular dislike among a certain demographic group of a particular vehicle setting in one of the manufacturer's cars. As discussed above, patterns in vehicle setting data can be determined by neural networks in the network server.

Implementations described above provide a comprehensive, effective, and efficient method of processing vehicle setting data from drivers and vehicles, and sharing the vehicle setting data in a controlled and desirable manner. For example, vehicle manufacturers may receive feedback regarding their vehicles without having to conduct an extensive market survey. Customers are protected because their identities are not shared with the vehicle manufacturers, but, simultaneously, they can provide information to vehicle manufacturers that can help the manufacturers make improvements in existing and future models.

Additionally, the described implementations provide an effective method for drivers to share vehicle setting data with their social network and for fans or followers to receive information about the vehicle settings of drivers they would like to follow or learn more about.

Embodiments and all of the functional operations and/or actions described in this specification may be implemented in digital electronic circuitry, or in computer software, firmware, or hardware, including the structures disclosed in this specification and their structural equivalents, or in combinations of one or more of them. Embodiments may be implemented as one or more computer program products, e.g., one or more modules of computer program instructions encoded on a computer readable medium for execution by, or to control the operation of, data processing apparatus. The computer-readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine- generated electrical, optical, or electromagnetic signal that is generated to encode information for transmission to suitable receiver apparatus.

A computer program, also known as a program, software, software application, script, or code, may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data in a single file dedicated to the program in question, or in multiple coordinated files. A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

Elements of a computer may include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer may not have such devices. Moreover, a computer may be embedded in another device, e.g., a tablet computer, a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user or driver, embodiments may be implemented on one or more computers having a display device, e.g., a cathode ray tube (CRT), liquid crystal display (LCD), or light emitting diode (LED) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and may even be claimed as such, one or more features from a claimed combination may in some cases be excised from the combination, and the claimed combination may be directed to a sub-combination or variation of a sub-combination.

Similarly, while actions are depicted in the drawings in a particular order, this should not be understood as requiring that such actions be performed in the particular order shown or in sequential order, or that all illustrated actions be performed, to achieve desirable results. For example, operations 374-380 executed by network server 330 may be executed in various orders and are not limited to the sequential order of the reference numbers assigned to the operations. Moreover, the separation of various system components in the embodiments described above should not be understood as requiring such separation in all embodiments, and it should be understood that the described program components and systems may generally be integrated together in a single software product or packaged into multiple software products.

Thus, particular implementations have been described. Other implementations are within the scope of the following claims. For example, the actions recited in the claims may be performed in a different order and still achieve desirable results.

What is claimed is:

1. A computer-implemented method comprising:
receiving (i) vehicle setting data for one or more vehicles associated with a particular driver, and (ii) vehicle setting preference information for the particular driver;
processing, by one or more processors, the vehicle setting data based on the vehicle setting preference information for the particular driver;
storing, by the one or more processors, the processed vehicle setting data in a cloud-based server; and
transmitting the processed vehicle setting data to one or more third parties based on the vehicle setting preference information.

2. The computer-implemented method of claim 1, wherein the vehicle setting data includes one or more of mirror positions, a driver seat position, steering wheel position, foot pedal positions, radio station presets, radio stations tuned into, heating, ventilation, air conditioning (HVAC) settings, vehicle lighting preferences, wiper speed settings, navigation settings, camera bumper settings, safety alert settings, child lock settings, and window lock settings.

3. The computer-implemented method of claim 1, wherein vehicle setting preference information for the particular driver includes one or more of:
data identifying a social network to share one or more portions of the vehicle setting data with;
data identifying a contact in a social network who can receive one or more portions of the vehicle setting data;
data indicative of one or more rules designated by the particular driver for processing the vehicle setting data;
data indicating whether all portions of the vehicle setting data or only one or more portions selected by the particular driver are to be shared; and
data indicative of a selection by the driver to abstract the vehicle setting data.

4. The computer-implemented method of claim 1, wherein processing the vehicle setting data based on the vehicle setting preference information for the particular driver comprises:
abstracting the vehicle setting data for the particular driver to remove identification information of the particular driver.

5. The computer-implemented method of claim 1, wherein processing the vehicle setting data based on the vehicle setting preference information for the particular driver comprises one or more of:
generating one or more driver profiles based on the vehicle setting data associated with a plurality of drivers including the particular driver; and
generating one or more vehicle make and model profiles based on the vehicle setting data associated with a plurality of drivers including the particular driver.

6. The computer-implemented method of claim 1, wherein storing the processed vehicle setting data in the cloud-based server comprises:
storing the processed vehicle setting data in one or more of (I) an Internet cloud- based database, and (II) a portable electronic device associated with the particular driver.

7. The computer-implemented method of claim 1, wherein storing the processed vehicle setting data in the cloud-based server comprises:
storing the processed vehicle setting data based on one or more of (I) a vehicle make or model associated with the processed vehicle setting data, (II) a driver profile associated with the processed vehicle setting data, and (III) an identified driver profile associated with the processed vehicle setting data.

8. The computer-implemented method of claim 1, wherein storing the processed vehicle setting data in the cloud-based server comprises:
storing the processed vehicle setting data in response to determining that rules included in the vehicle setting preference information for the particular driver are satisfied.

9. The computer-implemented method of claim 1, wherein the one or more third parties include:
one or more manufacturers, respectively, of the one or more vehicles identified in the vehicle setting data;
a social network;
a ride-sharing organization;
a supplier of vehicle parts; and
one of more contacts of the particular driver.

10. The computer-implemented method of claim 1, further comprising:
receiving vehicle setting data associated with a plurality of drivers;
determining a particular vehicle make and model that is detected in (I) the vehicle setting data associated with a plurality of drivers and (II) the vehicle setting data for one or more vehicles associated with the particular driver; and
determining vehicle setting values for the determined particular vehicle make and model based on the vehicle setting data associated with a plurality of drivers and the vehicle setting data for one or more vehicles associated with the particular driver,
wherein transmitting the processed vehicle setting data to the one or more third parties based on the vehicle setting preference information comprises transmitting the vehicle setting values for the identified particular vehicle make and model.

11. The computer-implemented method of claim 1, further comprising:
receiving vehicle setting data associated with a plurality of drivers;
determining a particular driver profile based on (I) the vehicle setting data associated with a plurality of drivers and (II) the vehicle setting data for one or more vehicles associated with the particular driver; and
determining vehicle setting values for the determined particular driver profile based on the vehicle setting data associated with a plurality of drivers and the vehicle setting data for one or more vehicles associated with the particular driver,
wherein transmitting the processed vehicle setting data to the one or more third parties based on the vehicle setting preference information comprises transmitting the vehicle setting values for the identified particular driver profile to a device of a driver having a profile matching the identified particular driver profile.

12. The computer-implemented method of claim 1, further comprising:
receiving vehicle setting data associated with a plurality of drivers; and
detecting one or more vehicle setting patterns in one or more of the vehicle setting data associated with a plurality of drivers and the vehicle setting data for one or more vehicles associated with the particular driver,
wherein transmitting the processed vehicle setting data to the one or more third parties based on the vehicle setting preference information comprises transmitting data indicative of the one or more vehicle setting patterns.

13. The computer-implemented method of claim 12, wherein the one or more vehicle setting patterns include:
one or more patterns of vehicle setting values associated with a particular demographic group of drivers;
one or more patterns of vehicle setting values associated with a particular vehicle make and model; and
one or more patterns of vehicle setting values associated with a particular driver profile.

14. The computer-implemented method of claim 1, further comprising:
determining a value indicative of a level of similarity between (I) vehicle setting values included in the vehicle setting data for the one or more vehicles associated with the particular driver, and (II) vehicle setting values included in a profile of a driver other than the particular driver; and
transmitting data including the value indicative of the level of similarity to a device associated with the particular driver.

15. A non-transitory computer-readable storage medium comprising instructions, which, when executed by one or more computers, cause the one or more computers to perform actions comprising:
receiving (i) vehicle setting data for one or more vehicles associated with a particular driver, and (ii) vehicle setting preference information for the particular driver;
processing the vehicle setting data based on the vehicle setting preference information for the particular driver;
storing the processed vehicle setting data in a cloud-based server; and
transmitting the processed vehicle setting data to one or more third parties based on the vehicle setting preference information.

16. The non-transitory computer-readable storage medium of claim 15, wherein vehicle setting preference information for the particular driver includes one or more of:
data identifying a social network to share one or more portions of the vehicle setting data with;
data identifying a contact in a social network who can receive one or more portions of the vehicle setting data;
data indicative of one or more rules designated by the particular driver for processing the vehicle setting data;
data indicating whether all portions of the vehicle setting data or only one or more portions selected by the particular driver are to be shared; and
data indicative of a selection by the driver to abstract the vehicle setting data.

17. The non-transitory computer-readable storage medium of claim 15, wherein the one or more third parties include:
one or more manufacturers, respectively, of the one or more vehicles identified in the vehicle setting data;
a social network;
a ride-sharing organization;
a supplier of vehicle parts; and
one of more contacts of the particular driver.

18. A system comprising:
one or more computers and one or more storage devices storing instructions that are operable and when executed by one or more computers, cause the one or more computers to perform actions comprising:
receiving (i) vehicle setting data for one or more vehicles associated with a particular driver, and (ii) vehicle setting preference information for the particular driver;
processing the vehicle setting data based on the vehicle setting preference information for the particular driver;
storing the processed vehicle setting data in a cloud-based server; and
transmitting the processed vehicle setting data to one or more third parties based on the vehicle setting preference information.

19. The system of claim 18, wherein vehicle setting preference information for the particular driver includes one or more of:
data identifying a social network to share one or more portions of the vehicle setting data with;
data identifying a contact in a social network who can receive one or more portions of the vehicle setting data;
data indicative of one or more rules designated by the particular driver for processing the vehicle setting data;
data indicating whether all portions of the vehicle setting data or only one or more portions selected by the particular driver are to be shared; and
data indicative of a selection by the driver to abstract the vehicle setting data.

20. The system of claim 19, wherein the one or more third parties include:
one or more manufacturers, respectively, of the one or more vehicles identified in the vehicle setting data;
a social network;
a ride-sharing organization;
a supplier of vehicle parts; and
one of more contacts of the particular driver.
